(19) United States
(12) Patent Application Publication
(10) Pub. No.: US 2013/0151336 A1
(43) Pub. Date: Jun. 13, 2013

(54) Method, System and Program Product for Presenting Advertisement

(71) Applicant: Gary Goralnick, Woodland Hills, CA (US)

(72) Inventor: Gary Goralnick, Woodland Hills, CA (US)

(21) Appl. No.: 13/419,314

(22) Filed: Mar. 13, 2012

Related U.S. Application Data
(60) Provisional application No. 61/630,426, filed on Dec. 12, 2011.

(51) Int. Cl. G06Q 30/02

(52) U.S. Cl. 705/14.54

(57) ABSTRACT

A method, system and program product comprises capturing a conversation in an electronic format. At least one individual, engaged in the conversation, possesses an electronic device being configured to be operable for listening to the conversation. The captured conversation is converted into a representation of words comprised in the conversation. At least one word in the representation is searched for that matches a word in a stored list of keywords. An advertisement associated with a matched keyword is displayed to at least the one individual.

### CROSS-REFERENCE TO RELATED APPLICATIONS

The present Utility patent application claims priority benefit of the U.S. provisional application for patent Ser. No. 61/630,426 filed on Dec. 12, 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to advertising systems. More particularly, one or more embodiments of the invention relate to an advertising system associated with audio.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Avenues available to advertisers include newspaper, magazines, television commercials, radio advertisements, billboards, direct mail, Internet websites, email and text messages.

Commercial advertisers seek to generate increased consumption of their products or services via presentation of advertisements.

Advertisements present information associated with a product or service with the intent of persuading a viewer to purchases the product or service.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an example communication system, in accordance with an embodiment of the present invention;

FIG. 2 is a diagram illustrating use of the example communication system described with reference to FIG. 1, in accordance with an embodiment of the present invention;

FIG. 3 is a diagram illustrating use of the example communication system described with reference to FIG. 1, in accordance with an embodiment of the present invention;

FIG. 4 illustrates an example method for the communication system as described with reference to FIGS. 1-3, in accordance with an embodiment of the present invention;

FIG. 5 illustrates a block diagram depicting a conventional client/server communication system; and

FIG. 6 illustrates a typical computer system that, when appropriately configured or designed, may serve as a computer system 600 for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A communication system will be described which provides means and methods for presenting advertisement information for viewing associated with communicated audio information and for selection of presented advertisement information in order to view additional information.

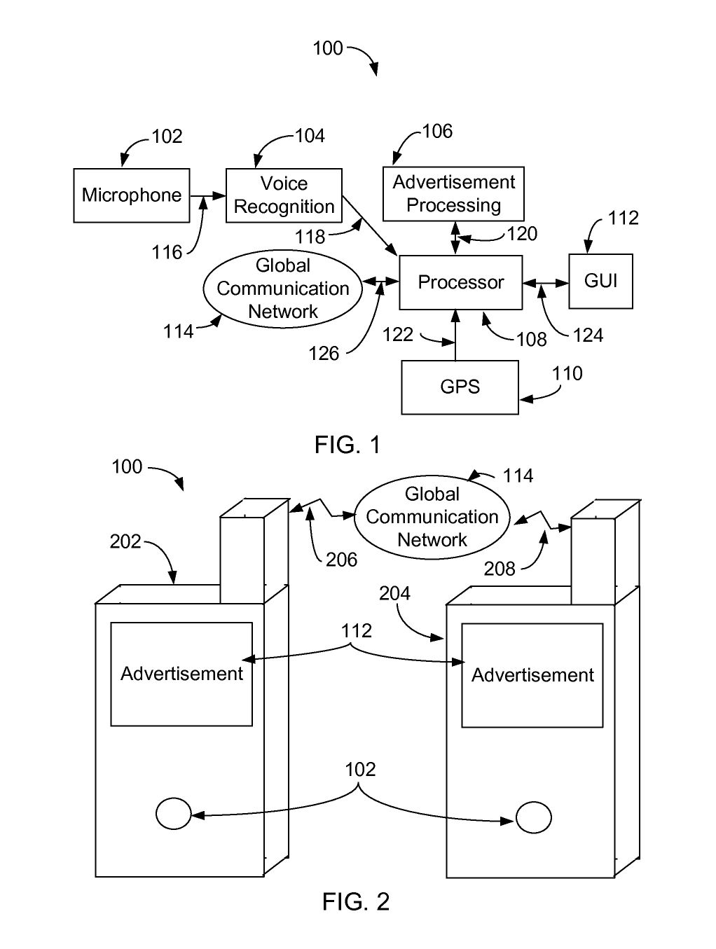

The system will now be described in detail with reference to FIGS. 1-6.

FIG. 1 is a block diagram of an example communication system, in accordance with an embodiment of the present invention.

A communication system 100 includes a microphone portion 102, a voice recognition portion 104, an advertisement processing portion 106, a processor portion 108, a Global Positioning System (GPS) portion 110, a Graphical User Interface (GUI) portion 112 and a global communication network 114.

Voice recognition portion 104 receives information from microphone portion 102 via a communication channel 116. Processor portion 108 receives information from voice recognition portion 104 via a communication channel 118. Processor portion 108 communicates bi-directionally with advertisement processing portion 106 via a communication channel 120. Processor portion 108 receives information from GPS portion 110 via a communication channel 122. Processor portion 108 communicates bi-directionally with GUI portion 112 via a communication channel 124. Processor portion 108 communicates bi-directionally with global communication network 114 via a communication channel 126.

Communication system 100 provides capability for exchanging information for purposes of communication. Non-limiting examples of communication exchanged include audio, video and images. Non-limiting examples for implementing communication system 100 include cellular telephone, mobile computing device, tablet computing device, notebook computer, netbook computer and fast-food restaurant order kiosk.

Microphone portion 102 receives, processes and communicates audio information received via the atmosphere.

Voice recognition portion 104 receives and processes audio information for converting the audio information to data associated with language. As a non-limiting example, reception of the word “hello” spoken by a person is converted to a data representation of the word “hello”.

Processor portion 108 receives, processes and communicates information for controlling the operation of audio communication system 100.

GPS portion 110 receives and processes information from positioning satellites for communicating geographic location information.

GUI portion 112 receives, processes and presents information for viewing. As a non-limiting example, GUI portion 112 may present advertisements for viewing. As another non-limiting example, advertisements may include information for an Internet website or for a telephone number to call to receive additional information.

Global communication network 114 receives, processes and communicates information between entities. As non-limiting examples, global communication network 114 may be configured as the Internet and/or as a cellular telephone communication network.

In operation, processor portion 108 receives and processes information associated with advertising from global communication network 114. Furthermore, processor portion 108 communicates advertising information to advertisement processing portion 106. Non-limiting examples of advertisement information received include advertisements to present for viewing, keyword selections for presenting information and geographic locations for presenting information. Processor portion 108 receives and processes information received from global communication network 114 and GUI portion 112 for presenting information via GUI portion 112. As a non-limiting example, a user (not shown) may seek to communicate verbally with another user (not shown). A user speaks a word, phrase, sentence, etc. and microphone receives and processes audio information. Voice recognition portion 104 receives audio information and converts the audio information to a data representation of the audio information. Processor portion 108 receives audio data from voice recognition portion 104 and geographic location information from GPS portion 110 and communicates information to advertisement processing portion 106. Advertisement processing portion 106 receives and processes audio data and geographic location information. Advertisement processing portion 106 communicates advertisement information to processor portion 108. Processor portion 108 communicates advertisement information to GUI portion 112. User views advertisement information view GUI portion 112. User may select to access additional information via selection of presented advertisement or calling a telephone number provided by advertisement.

As a non-limiting example, a user may be presented with advertisement information via a GUI associated with an automobile. Furthermore, following a conversation performed within the automobile or via the automobile's communication system, an advertisement associated with keywords spoken during the conversation is presented for viewing via the GUI.

As a non-limiting example, a user may be presented with advertisement information via a communication device GUI associated with a conversation from a previous communication exchange.

As a non-limiting example, a user communicating via a social networking website or via a video teleconference may be presented with advertisement associated audio information exchanged during the communication exchange.

As a non-limiting example, a user may be presented with textual and/or graphical advertisement information associated with audio information exchanged during a conversation. As a non-limiting example, the presented information may be communicated via email. As a non-limiting example, the conservation may be performed and the advertisement information presented via a television or radio configured with communication capabilities.

As non-limiting examples, a user may be presented advertisement information associated with postal zip code location or GPS location information.

As a non-limiting example, advertisement information may be presented based upon selected keywords or all words from the program present within exchanged verbal information. In some alternative embodiments, key words may also or instead be selected by the user from a list of words presented by the program or words that the user comes up with to input into the program or a certain amount of words or any amount of words before any verbal exchange

As a non-limiting example, advertisement information may be presented based upon information exchanged during a conversation associated with an industry.

As a non-limiting example, a viewer of an advertisement presented via an electronic device may select the advertisement in order to receive additional information associated with the advertisement/promotion.

As a non-limiting example, verbal information exchanged during presentation of information (e.g. movie, TV show, etc.) may be received and processed in order to present an advertisement associated with the verbal information.

As a non-limiting example, presentation of advertisements may be selected for viewing or for not viewing.

As a non-limiting example, receipt and processing of verbal information for presenting advertisement information may be configured for use via applications (e.g. game) associated with computing devices.

In some alternative embodiments of the present invention, the verbal recognition processing is done either locally on the user's electronic device (or computing system) or on an associated server.

In some alternative embodiments of the present invention, the verbal recognition processing may be performed one electronic device/system while the associated Ad presenting methods and/or display are performed on another electronic device.

By way of example, and not limitation, hearing a song from the radio on a user's cell phone or computer, or any other device, may convert those words into advertisements on a television. Likewise, the method may take what is being said on the television and translate those words to pertinent advertisements displayed on another device.

As a non-limiting example, operation of advertisement presentation may be selected or unselected via a verbal keyword or password. Furthermore, keyword/password may be received before or during an exchange of verbal information.

As a non-limiting example, presentation of advertisements associated with received verbal information may be configured for operation via computing devices presenting media for viewing. Non-limiting examples for media include books and magazines.

As a non-limiting example, presentation of advertisements associated with received verbal information may be associated with an exchange of verbal information between a person and a computing device; e.g., without limitation, a robot, computer Cell Phone hand held computer. An example, without limitation, of one practical application is when talking into the electronic device the words said from the human or the words said from the electronic device can be done both ways or just one way from the human or the electronic device would have advertisements to those words

FIG. 1 is a block diagram of an example communication system where an advertisement is presented based upon information contained within an exchange of verbal information.

FIG. 2 is a diagram illustrating use of the example communication system described with reference to FIG. 1, in accordance with an embodiment of the present invention.

Communication system 100 includes a mobile communication device 202, a mobile communication device 204 and global communication network 114.

Mobile communication device 202 communicates bi-directionally with global communication network 114 via a communication channel 206. Mobile communication device 204 communicates with global communication network 114 via a communication channel 208. As a non-limiting example, communication channel 206 and communication channel 208 may be configured as wireless.

Mobile communication device 202 and mobile communication device 204 include microphone portion 102 and GUI portion 112.

Mobile communication device 202 and mobile communication device 204 provide capability for exchanging information and for presenting information for viewing. Non-limiting examples for information exchanged include audio and video. Non-limiting examples for mobile communication device 202 and 204 include cellular telephone, tablet computing device and smartphone.

In operation, a first user (not shown) associated with mobile communication device 202 exchanges audio information with a second user (not shown) associated with mobile communication device 204. Audio information is received from the users via microphone portion 102. Audio information exchanged is received and processed with advertisement information presented via GUI portion 112 based upon information contained within exchanged audio information.

FIG. 2 is a diagram illustrating use of the example communication system described with reference to FIG. 1 where advertisements are presented based upon information contained within exchanged audio information.

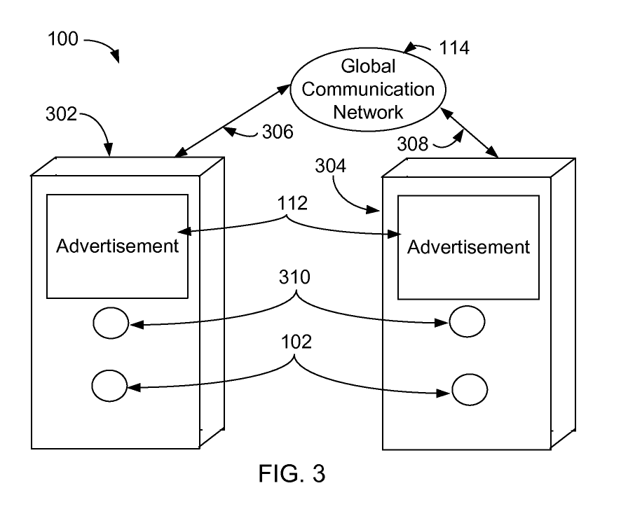

FIG. 3 is a diagram illustrating use of the example communication system described with reference to FIG. 1, in accordance with an embodiment of the present invention.

Communication system 100 includes a communication device 302 and a communication device 304 and global communication network 114.

Communication device 302 communicates bi-directionally with global communication network 114 via a communication channel 306. Communication device 304 communicates with global communication network 114 via a communication channel 308. As a non-limiting example, communication channel 306 and communication channel 308 may be configured as a local area network.

Communication device 302 and communication device 304 include microphone portion 102, GUI portion 112 and a video camera portion 310.

Video camera portion 310 provides capability for capturing and communicating video information.

Communication device 302 and communication device 304 provide capability for exchanging information and for presenting information for viewing. Non-limiting examples for information exchanged include audio and video. Non-limiting examples for communication device 302 and 304 include television with video capability, video conferencing equipment and computing device with video capability.

In operation, a first user (not shown) associated with communication device 302 exchanges audio information with a second user (not shown) associated with communication device 304. Audio information is received from the users via microphone portion 102. Audio information exchanged is received and processed with advertisement information presented via GUI portion 112 based upon information contained within exchanged audio information.

FIG. 3 is a diagram illustrating use of the example communication system described with reference to FIG. 1 where advertisements are presented based upon information contained within exchanged audio information.

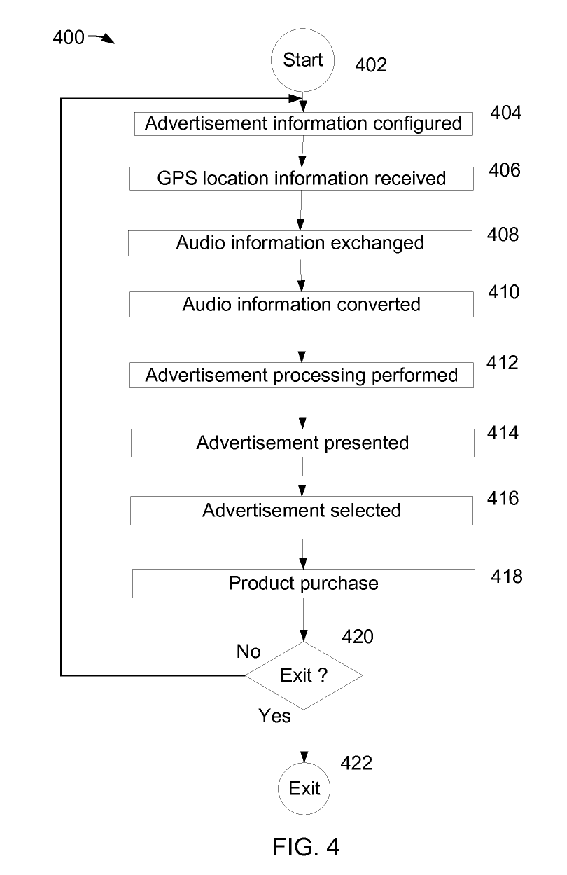

FIG. 4 illustrates an example method for the communication system as described with reference to FIGS. 1-3, in accordance with an embodiment of the present invention.

Referring to FIG. 4, a method 400 initiates in a step 402.

Then in a step 404, advertisement information is configured.

As a non-limiting example, advertisement information for presentation, geographic location information and keywords associated with advertisements are downloaded/configured. Furthermore, advertisement information, geographic location information and keywords are communicated to advertisement processing portion 106 (FIG. 1) via global communication network 114 (FIG. 1) and processor portion 108 (FIG. 1). Furthermore, as a non-limiting example, a user may configure to present an advertisement for a product when a user is located within certain zip code. Furthermore, as a non-limiting example, a user may configure to present an advertisement for a product when the word “product” is mentioned by a user.

Referring back to FIG. 4, then in a step 406, GPS information is received.

As a non-limiting example, GPS information is received from positioning satellites and processed via GPS portion 110 (FIG. 1). Furthermore, GPS information is communicated to advertisement processing portion 106 (FIG. 1) via processor portion 108 (FIG. 1). Furthermore, as a non-limiting example, the information received and processed by GPS portion 110 (FIG. 1) may indicate mobile communication device 202 (FIG. 2) is located at the corner of 1^{st} and Main Street in Somewhere U.S.A.

Referring back to FIG. 4, then in a step 408 audio information is exchanged.

As a non-limiting example, audio information is exchanged between mobile communication device 202 (FIG. 2) and mobile communication device 204 (FIG. 2). Furthermore, as a non-limiting example, audio information exchanged includes the word “product’.

Referring back to FIG. 4, then in a step 410 exchanged audio information is converted.

As a non-limiting example, received audio information is converted to its data representation via voice recognition portion 104 (FIG. 1) and communicated to advertisement processing portion 106 (FIG. 1). Furthermore, as a non-limiting example, the received audio representation of “product” is converted to a digital format for “product”.

Referring back to FIG. 4, then in a step 412 advertisement processing is performed.

As a non-limiting example, advertisement processing portion 106 (FIG. 1) receives the digital representation of “product” and searches for advertisements to be presented associated with the term “product”. Furthermore, advertisement processing portion 106 (FIG. 1) searches for advertisements to be presented based upon the geographic location of the corner of 1^{st} and Main Street in Somewhere U.S.A.

Referring back to FIG. 4, then in a step 414 advertising information is presented for viewing.

As a non-limiting example, advertisement information is presented via GUI portion 112 (FIG. 1) by way of processor portion 108 (FIG. 1). Furthermore, as a non-limiting example, an advertisement associated with the term “product” is presented for viewing. Furthermore, as a non-limiting example, an advertisement associated with the corner of 1^{st} and Main Street in Somewhere U.S.A. is presented for viewing.

Referring back to FIG. 4, then in a step 416 a presented advertisement is selected for viewing additional information.

As a non-limiting example, user selects to view additional information associated with an advertisement via GUI portion 112 (FIG. 1). Furthermore, request for additional information associated with advertisement is communicated to global communication network 114 (FIG. 1) with the supplied additional information communicated from global communication network 114 (FIG. 1) to GUI portion 112 (FIG. 1) via processor portion 108 (FIG. 1). Furthermore, as a non-limiting example, additional information associated with the “product” advertisement is presented for viewing via GUI portion 112 (FIG. 1). Furthermore, as a non-limiting example, additional information associated with the corner of 1^{st} and Main Street in Somewhere U.S.A is presented for viewing via GUI portion 112 (FIG. 1).

Referring back to FIG. 4, then in a step 418 a product is purchased.

As a non-limiting example, user selects to purchase product via GUI portion 112 (FIG. 1). Furthermore, purchase request is communicated from GUI portion 112 (FIG. 1) to global communication network via processor portion 108 (FIG. 1).

Referring back to FIG. 4, then in a step 420 a determination is performed for exiting method 400.

For a determination of not exiting method 400 in step 420, execution of method 400 transitions to step 404.

For a determination of exiting method 400 in step 420, execution of method 400 terminates in a step 422.

FIG. 4 illustrates an example method for the communication system as described with reference to FIGS. 1-3 where advertising information is configured, GPS location information is received and processed, audio information is exchanged, audio information is converted, advertisement processing is performed, advertisement is presented, advertisement is selected and product is purchased.

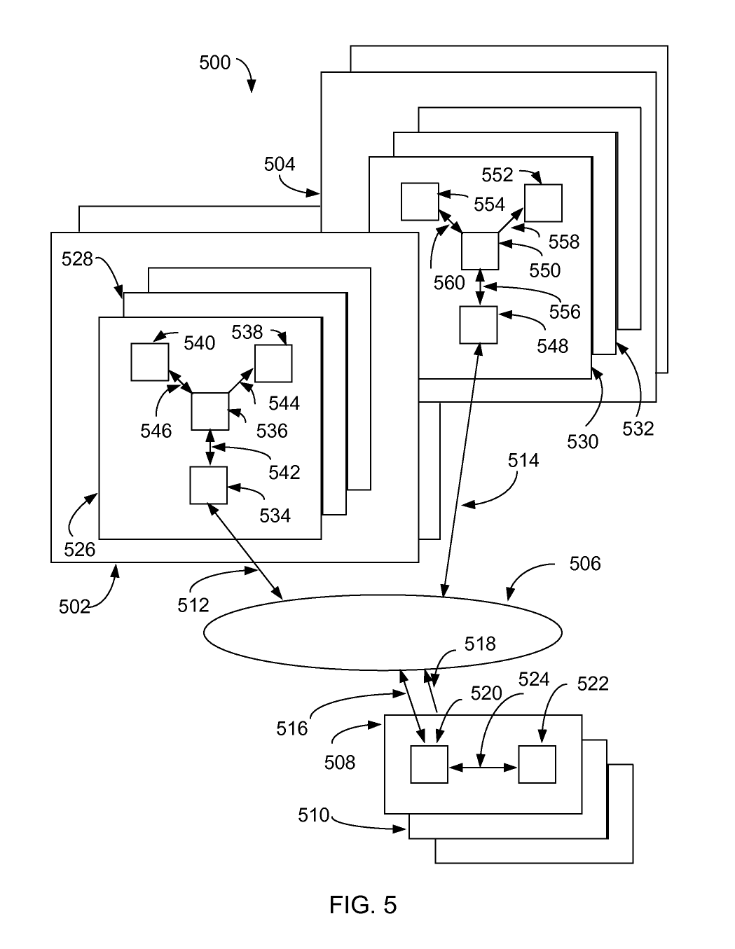

FIG. 5 illustrates a block diagram depicting a conventional client/server communication system.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate bi-directionally and also communicate bi-directionally with other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 536 may communicate the return information to GUI 538 via communication channel 544. User may then view the return information on GUI 538.

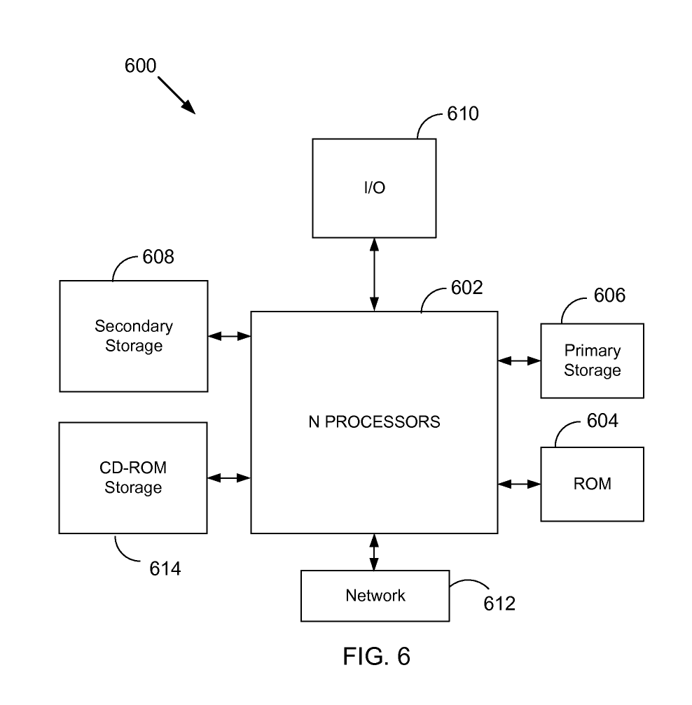

FIG. 6 illustrates a typical computer system that, when appropriately configured or designed, may serve as a computer system 600 for which the present invention may be embodied.

Computer system 600 includes a quantity of processors 602 (also referred to as central processing units, or CPUs) that may be coupled to storage devices including a primary storage 606 (typically a random access memory, or RAM), a primary storage 604 (typically a read-only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 typically may be used to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and typically may be used as a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of an advertisement communication system according to the present invention will be apparent to those skilled in the art. The invention has been described above by way of illustration, and the specific embodiments disclosed are not intended to limit the invention to the particular forms disclosed. For example, the particular implementation of the GUI may vary depending upon the particular type of computing device used. The computing devices described in the foregoing were directed to smartphone implementations; however, similar techniques using tablet computing implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. One or more computer storage media storing computer-usable instructions, that when used by one or more computing devices, cause the one or more computing devices to perform a method comprising the steps of:
capturing, in an electronic format, at least a portion of a conversation of at least one individual engaged in the conversation, said conversation being captured via an electronic device, said electronic device being configured to be operable for communicating said electronic format of the conversation to at least one of the computing devices;
converting at least a portion of the captured conversation into a representation of words comprised in the conversation;
searching for at least one word in the representation that matches a word in a stored list of keywords; and
displaying at least one advertisement associated with a matched keyword, said advertisement being displayed on a device operable to be viewed by at least the one individual.

2. The method as recited in claim 1, further comprising the step of obtaining location information for the one individual, in which the advertisement displayed is associated with the matched keyword and the location information.

3. The method as recited in claim 1, further comprising the steps of obtaining a plurality of advertisements associated with the keywords, and storing the plurality of advertisements.

4. The method as recited in claim 1, further comprising the step of obtaining the list of keywords.

5. The method as recited in claim 4, in which the list of keywords is obtained from a provider of the advertisements and/or the user.

6. The method as recited in claim 5, further comprising the step of obtaining a selection of the provider from which to obtain the advertisements.

7. The method as recited in claim 1, further comprising the step of enabling the one individual to make a selection for obtaining additional information associated with the displayed advertisement.

8. The method as recited in claim 1, further comprising the step of enabling the one individual to make a selection for purchasing a product associated with the displayed advertisement.

9. The method as recited in claim 1, further comprising the steps of recognizing a password in the representation, and disabling said displaying upon said recognizing.

10. A system comprising:
a microphone device being configured to be operable for listening to a conversation from at least one individual, said microphone device capturing at least a portion of the conversation in an electronic format;
a voice recognition unit being configured to be operable for converting at least a portion of the captured conversation into a representation of words comprised in the conversation;
a processing unit being configured to be operable for searching for at least one word in the representation that matches a word in a stored list of keywords, and for selecting at least one advertisement associated with a matched keyword; and
a display unit being configured to be operable for displaying the advertisement on a device operable to be viewed by at least the one individual.

11. The system as recited in claim 10, further comprising a location processing unit being configured to be operable for determining location information for the one individual, in which said processing unit is further configured to be operable for using the location information in selecting the advertisement.

12. The system as recited in claim 10, further comprising a communication unit being configured to be operable for communicating with a provider, in which said processing unit is further operable for obtaining a plurality of advertisements associated with the keywords, and storing the plurality of advertisements.

13. The system as recited in claim 12, in which said processing unit is further configured to be operable for obtaining the list of keywords.

14. The system as recited in claim 13, in which the list of keywords is obtained from the provider of the advertisements.

15. The system as recited in claim 12, in which said processing unit is further configured to be operable for obtaining a selection of the provider from which to obtain the advertisements.

16. The system as recited in claim 10, in which said processing unit is further configured to be operable for enabling the one individual to make a selection for obtaining additional information associated with the displayed advertisement.

17. The system as recited in claim 10, in which said processing unit is further configured to be operable for enabling the one individual to make a selection for purchasing a product associated with the displayed advertisement.

18. The system as recited in claim 10, in which said processing unit is further configured to be operable for recognizing a password in the representation, and disabling the display unit upon said recognizing.

19. A non-transitory program storage device readable by a machine tangibly embodying a program of instructions executable by the machine to perform a method for presenting advertisement, comprising:
computer code for capturing, in an electronic format, at least a portion of a conversation of at least one individual engaged in the conversation, said conversation being captured via an electronic device, said electronic device being configured to be operable for communicating said electronic format of the conversation to at least one of the computing devices;
computer code for converting at least a portion of the captured conversation into a representation of words comprised in the conversation;
computer code for searching for at least one word in the representation that matches a word in a stored list of keywords; and
computer code for displaying at least one advertisement associated with a matched keyword, said advertisement being displayed on a device operable to be viewed by at least the one individual.

20. The non-transitory program storage device as recited in claim 19, further comprising:
computer code for obtaining location information for the one individual, in which the advertisement displayed is associated with the matched keyword and the location information;
computer code for obtaining a plurality of advertisements associated with the keywords, and storing the plurality of advertisements;
computer code for obtaining the list of keywords, in which the list of keywords is obtained from a provider of the advertisements;
computer code for obtaining a selection of the provider from which to obtain the advertisements;
computer code for enabling the one individual to make a selection for obtaining additional information associated with the displayed advertisement;
computer code for enabling the one individual to make a selection for purchasing a product associated with the displayed advertisement; and
computer code for recognizing a password in the representation, and disabling said displaying upon said recognizing.
